(19) United States
(12) Patent Application Publication
(10) Pub. No.: US 2010/0320926 A1
(43) Pub. Date: Dec. 23, 2010

(54) Sine wave light modulation control method and device

(76) Inventor: Kun-Pai Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,605

(22) Filed: Jun. 17, 2009

(51) Int. Cl. H05B 41/36

(52) U.S. Cl. 315/246

(57) ABSTRACT

A light modulation control method applied to control a lamp is disclosed. The control method includes the following steps: first, providing an AC voltage; then, rectifying the AC voltage into a first DC pulse; modulating the first DC pulse into a modulated wave; filtering the modulated wave into a second DC pulse; finally, alternatingly switching the second DC pulse to a modulated AC voltage for the lamp through a switching unit.

### BACKGROUND OF THE INVENTION

1. Field of the Invention

The present invention relates to a light modulation device and method thereof; in particular, to a sine wave light modulation control method and a device that utilizes AC voltage.

2. Description of Related Art

Light modulation device for light fixtures generally use thyristor phase control, which utilizes the advantageous characteristics and features of a thyristor for adjusting the size of the conduction angle via phase control, so as to achieve the object of controlling the light output of light fixtures. Due to the fact that thyristors are permanent, non-consumable components, and their breakdown rate is low, this type of thyristor phase control for light modulation is still widely used today.

Refer to FIG. 1, which shows a prior art schematic diagram for a phase modulation type control device for adjusting light. As shown in FIG. 1, a light modulating circuit 1 formed with a thyristor (silicon controlled rectifier (SCR)/triode for alternating current (TRIAC)) controls the conduction angle to be added to the output voltage Vout at the two ends of a load 2. FIG. 2 shows the prior art wave form of the output voltage Vout, and as shown in FIG. 2, the light modulating circuit 1 may adjust and control the conduction angle 21 of the output voltage Vout, so as to achieve the effect of light modulation.

However, the aforementioned phase modulation control device for adjusting light performs positive phase modulation through SCR, for the simple fact that this type of light modulation control method is easy and effective. However, phase control generates a large amount of inrush current, leading to noise at the lamp, and therefore is likely to reduce the product life-span of the lamp. Additionally, this type of light modulation also generates high frequency interference, which may negatively affect power systems, and this type of light modulation method decreases the power factor of the load, so the alternating current (AC) voltage that has been inputted as power source cannot be effectively utilized, leading to wastage of power resource.

Therefore currently there are also light modulation methods that perform negative phase modulation via an insulated gate bipolar transistor (IGBT), so as to decrease effect of shortened product life-span of the lamp by limiting the inrush current. However, this type of control method still utilizes phase control, so that the problem issues of frequency interference, limited power efficiency, and low power factor remain.

### SUMMARY OF THE INVENTION

The present invention provides a sine wave light modulation control method and device, so as to resolve the issues of the light modulation method of the prior art, such as a low power factor and limited power efficiency. Thereby, an object of the present invention is to directly provide a sine wave to a lamp, and to control the light intensity of the lamp by controlling the magnitude of the sine wave voltage, so as to noticeably raise the power factor.

In order to resolve the aforementioned technical issue, according to an embodiment of the present invention, a sine wave light modulation control method is provided, for controlling the light output of a lamp, the method includes: providing an AC voltage; rectifying the AC voltage into a first direct current (DC) pulse; modulating the first DC pulse into a modulated wave via pulse width modulation (PWM); filtering the modulated wave into a second DC pulse; switching the second DC pulse into a modulated AC voltage via a switching unit for use by the lamp; wherein the switching of the switching unit is by alternatingly switching the second DC pulse to a first conduction path and a second conduction path so as to output the modulated AC voltage, and the directions of the first conduction path and the second conduction path for the second DC pulse transmitted to the lamp are opposite to each other.

In order to resolve the aforementioned technical issue, according to an embodiment of the present invention, a sine wave light modulation control device is provided, for controlling the light output of a lamp, the device includes: a rectifier unit, a modulator unit, a filter unit, a switching unit, and a control unit. Therein the rectifier unit is used for rectifying an AC voltage to output a first DC pulse; the modulator unit is coupled to the rectifier unit and is used for modulating the first DC pulse into a modulated wave via pulse width modulation; the filter unit is coupled to the modulator unit and is used for filtering the modulated wave into a second DC pulse; the switching unit is coupled to the filter unit, and the switching unit provides a first conduction path and a second conduction path for alternatingly switching between the two paths so as to output a modulated AC voltage for use by the lamp; the control unit is coupled to the switching unit, the control unit is used for controlling the switching unit to alternatingly provide the second DC pulse to the first conduction path and the second conduction path so as to output the modulated AC voltage, and the directions of the first conduction path and the second conduction path for the second DC pulse transmitted to the lamp are opposite to each other.

Therefore in the above embodiment, the present invention switches the second DC pulse into the modulated AC voltage, so that the modulated AC voltage is a sine wave, thereby the lamp operates with sine wave, so as to achieve the technical effect of elevating power factor.

The aforementioned illustrations and following detailed descriptions are exemplary for the purpose of further explaining the scope of the present invention. Other objectives and advantages related to the present invention will be illustrated in the subsequent descriptions and appended drawings.

### BRIEF DESCRIPTION OF THE DRAWINGS

FIG. 1 shows a prior art schematic diagram for a phase modulation type control device for adjusting light;

FIG. 2 shows the oscillogram of the output voltage Vout from the device of FIG. 1;

FIG. 3 shows a flow chart of a sine wave light modulation control method for according to a preferred embodiment of the present invention;

FIG. 4 shows a schematic diagram of an AC voltage performing light adjustment control via the method of FIG. 3;

FIG. 5 shows another schematic diagram of an AC voltage performing light adjustment control via the method of FIG. 3;

FIG. 6 shows a schematic diagram of a sine wave light modulation control device according to a preferred embodiment of the present invention;

FIG. 7 shows another schematic diagram of a sine wave light modulation control device according to a preferred embodiment of the present invention.

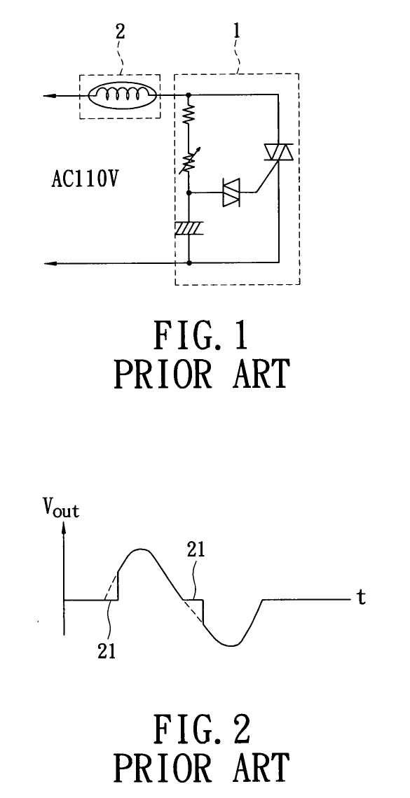

### DETAILED DESCRIPTION OF THE PREFERRED EMBODIMENTS

The present invention provides a sine wave light modulation control method and device with high power factor, for modulating the light intensity of a lamp, and a technical feature of the present invention is to directly provide sine wave for use by the lamp, so as to achieve the effect of light modulation by changing the voltage of the sine wave.

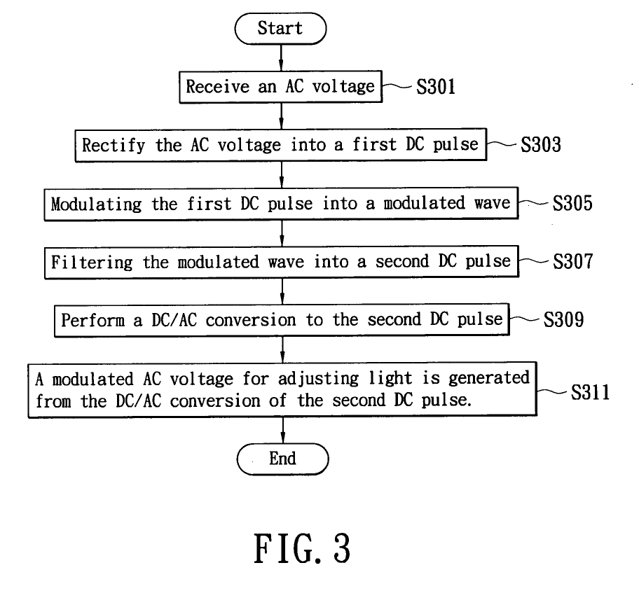

Please refer to FIG. 3, which shows a flow chart of a sine wave light modulation control method according to a preferred embodiment of the present invention. The present embodiment describes a sine wave light modulation control method for adjusting the light intensity of a lamp, the method includes the following steps:

First an AC voltage is provided from a power source (S301), and the power source maybe an utility outlet;

Next the AC voltage is rectified into a first DC pulse as output signal (S303);

Then modulate the first DC pulse into a modulated wave (S305), wherein the modulation of this step is done by high frequency pulse width modulation (PWM) to the first DC pulse, so as to determine the voltage of the first DC pulse according to the duty cycle of the pulse width;

The modulated wave is filtered into a second DC pulse for output (S307), because the modulated wave is generated by applying high frequency pulse width modulation to the first DC pulse, so that the modulated wave includes some high frequency signals. Therefore, the filtering in this step filters out the high frequency signal within the modulated wave via low-pass filtering;

Next the second DC pulse is converted into a modulated AC voltage via DC/AC conversion (S309), and the modulated AC voltage is a sine wave;

Lastly, the modulated AC voltage is provided directly for use by the lamp (S311), so that the lamp may light up according to the modulated AC voltage, thereby the light intensity of the lamp may change according to the voltage of the modulated AC voltage.

The aforementioned DC/AC conversion of step S309 is done by a switching unit that switches the output path of the second DC pulse, specifically the second DC pulse will be alternatingly switched to be outputted through the first conduction path and the second conduction path for every half cycle of the second DC pulse, and thereby converted by switching the second DC pulse into the modulated AC voltage, furthermore the directions of the first conduction path and the second conduction path for the second DC pulse transmitted to the lamp are opposite to each other.

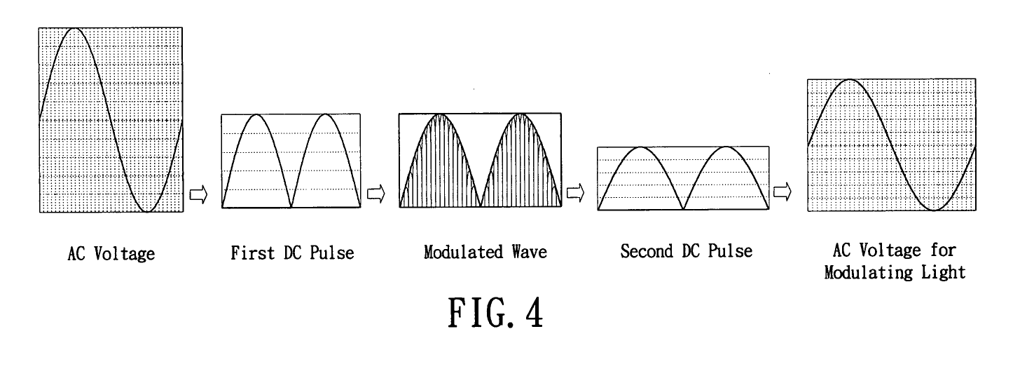

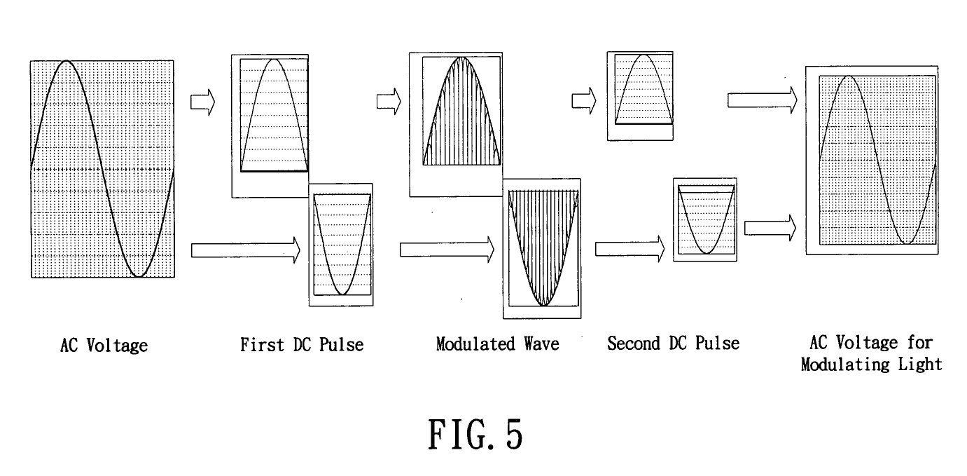

For further explanation of the various wave forms resulting from the steps in FIG. 3, please refer to FIG. 4 and 5, wherein FIG. 4 shows various wave forms resulting from the steps in FIG. 3 when full-wave rectification is utilized, and FIG. 5 shows various wave forms resulting form the steps in FIG. 3 when half-wave rectification is utilized.

Please refer to FIG. 4 in conjunction with FIG. 3, in FIG. 4 the AC voltage is rectified via full-wave rectification into a first DC pulse, so the first DC pulse is a full-wave DC pulse, next the first DC pulse is modulated via high frequency pulse width modulation into a modulated wave, and the modulated wave is further filtered via low-pass filtering into a second DC pulse, then the second DC pulse is converted via DC/AC conversion into a modulated AC voltage, and this modulated AC voltage is a sine wave that is directly provided to the lamp for use.

Next please refer to FIG. 5 in conjunction with FIG. 3, in FIG. 5 the AC voltage is rectified by half-wave rectification into a first DC pulse with its positive half cycle and negative half cycle separated, next the first DC pulse is modulated via high frequency pulse width modulation into a modulated wave with its positive half cycle and negative half cycle separated, and the modulated wave is further filtered via low-pass filtering into a second DC pulse with its positive half cycle and negative half cycle separated, then the second DC pulse is converted via DC/AC conversion into a modulated AC voltage, and this modulated AC voltage is a sine wave that is directly provided to the lamp for use.

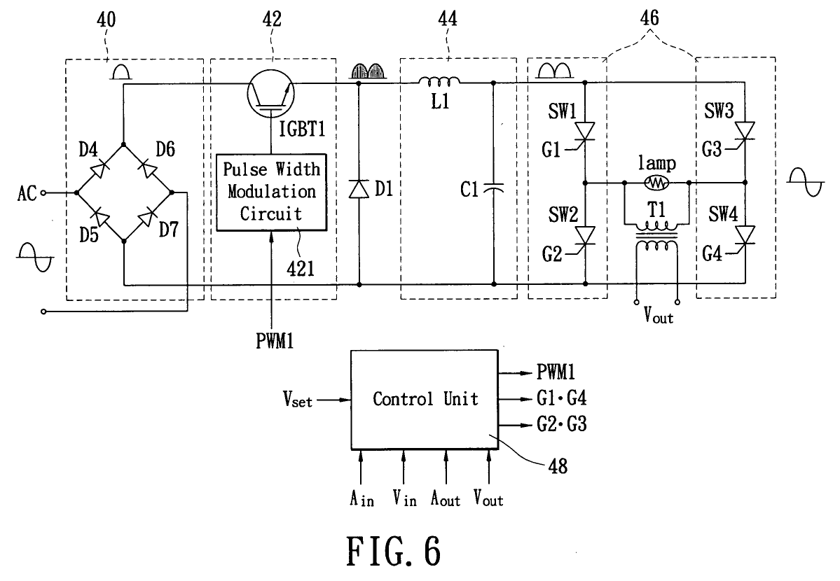

Next please refer to FIG. 6, which shows a schematic diagram of a sine wave light modulation control device according to a preferred embodiment of the present invention. The sine wave light modulation control device includes a rectifier unit 40, a modulator unit 42, a filter unit 44, a switching unit 46, and a control unit 48. Therein the rectifier unit 40 receives an AC voltage as input, and rectifies the AC voltage into a first DC pulse for output, in the present embodiment the rectifier unit 40 is a full wave rectifier circuit (such as a bridge rectifier circuit).

The modulator unit 42 is coupled to the output terminal of the rectifier unit 40, so as to receive the first DC pulse, and the first DC pulse is modulated via high frequency pulse width modulation into a modulated wave for controlling voltage. The modulator 42 of the present embodiment is composed of a power switch IGBT1 and a pulse width modulation driving circuit 421, wherein the pulse width modulation driving circuit controls the conduction or cut-off of the power switch IGBT1 via high frequency, thereby the first DC pulse may be modulated so as to generate the modulated wave that may vary in voltage.

The filter unit 44 is coupled to the output of the modulator unit 42, for receiving the modulated wave, and the filter unit 44 filters the high frequency signal of the modulated wave so as to output a second DC pulse. The filtering unit 44 of the present embodiment is a low pass filter circuit.

The switching unit 46 is coupled to the output of the filter unit 44, for converting by switching the second DC pulse into the modulated AC voltage to the lamp for use. The switching unit 46 of the present embodiment provides a plurality of switches, so as to form different conduction paths for the second DC pulse to travel to the lamp. The switching unit 46 shown in FIG. 6 includes switches SW1-SW4, wherein the switch SW1 and the switch SW2 are connected in series, the switch SW3 and the switch SW4 are connected in series, and the lamp is coupled between the switches SW1-SW4. The first conduction path is formed when the switch SW1 and the switch SW4 are in conduction, thereby the second DC pulse flows in the order and direction of switch SW1, the lamp, and the switch SW4; and the second conduction path is formed when the switch SW2 and the switch SW3 are in conduction. Thereby the second DC pulse flows in the order and direction of the switch SW3, the lamp, and the switch SW2. Thereby the directions of the aforementioned first and second conduction path are opposite to each other for the second DC pulse transmitted to the lamp; in other words, the switching unit 46 may convert the second DC pulse into a sine wave for use by the lamp.

The control unit 48 is coupled between the switching unit 46 and the modulator unit 42; the control unit 48 is primarily for controlling the operation of the switching unit 46 and the modulator 42. The control unit 48 outputs a control signal PWM1 to the pulse width modulation driving circuit 421 according to an input voltage Vset, whereby the input voltage Vset is used for adjusting the voltage of the sine wave that is provided to the lamp. The adjustment of the input voltage Vset may be initiated by pressing a key or button. For example, when the input voltage Vset may be adjusted between 0-100V AC, then if the input voltage is 50V AC, then the control signal PWM1 outputted by the control unit 48 is a pulse with 50% duty cycle.

Furthermore, in order to ensure the voltage of the sine wave utilized by the lamp accurately adheres to the input voltage Vset, the control unit 48 adopts feedback control mechanism. The control unit 48 receives a feedback voltage from the lamp, and compares this feedback voltage with the input voltage Vset. When the feedback voltage is greater than the input voltage Vset, then the control unit 48 lowers the duty cycle of the control signal PWM1; on the other hand if the feedback voltage is less than the input voltage Vset, then the control unit 48 increases the duty cycle of the control signal PWM1. As to how the control unit 48 receives this feedback voltage, this technique is will known to those skilled in the art, for example a transformer T1 may be connected at two ends of the lamp so as to receive the voltage at the two ends of the lamp.

Additionally, the control unit 48 also provides control of the switching unit 46. For example, the control units 48 may control the second DC pulse to alternatingly pass through the first conduction path or the second conduction path so as to reach the lamp, by controlling the conduction time of the plurality of switches SW1-SW4. To be more specific, the control unit 48 receives AC voltage from input Vin, and when the AC voltage is at the positive half cycle then the control unit 48 controls to conduct the switch SW1 and the switch SW4, and to cut-off the switch SW2 and the switch SW3; on the other hand, when the AC voltage is at the negative half cycle then the control unit 48 controls to conduct the switch SW2 and the switch SW3, and to cut-off the switch SW1 and the switch SW4.

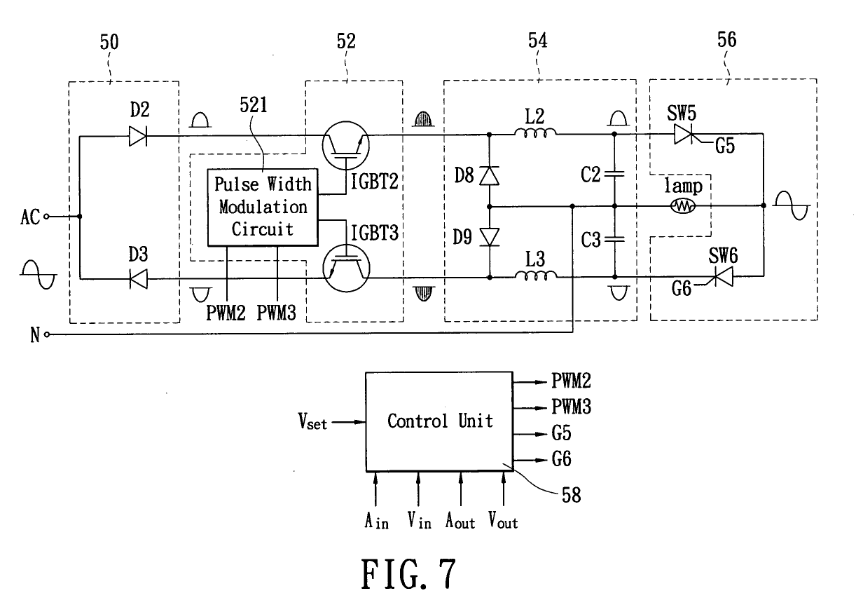

Next please refer to FIG. 7, which shows another schematic diagram of a sine wave light modulation control device according to a preferred embodiment of the present invention. The sine wave light modulation control device includes a rectifier 50, a modulator unit 52, a filter unit 54, a switching unit 56, and a control unit 58. Therein the rectifier unit 50 receives an AC voltage as input, and rectifies the AC voltage into a first DC pulse with a positive half cycle and a negative half cycle for output. The rectifier 50 of the present embodiment is a half wave rectifier circuit, and the half wave rectifier circuit includes a positive half wave rectifier circuit composed of diode D2 and a negative half wave rectifier circuit composed of diode D3.

The modulator unit 52 is coupled to the output terminal of the rectifier unit 50, so as to receive the first DC pulse, and the first DC pulse is modulated via high frequency pulse width modulation into a modulated wave for controlling voltage. The modulator unit 52 is includes two power switches IGBT2 and IGBT3, and a pulse width modulation driving circuit 521. Therein the pulse width modulation driving circuit 521 controls the conduction and cut-off of the power switches IGBT2 and IGBT3 at high frequency. Thereby, the first DC pulse with separated positive and negative half cycle may be modulated so as to generate the modulated wave that may vary in voltage.

The filter unit 54 is coupled to the output of the modulator unit 52, for receiving the modulated wave with separated positive and negative half cycle, and the filter unit 54 filters the high frequency signal of the modulated wave via low-pass filtering into a second DC pulse with separated positive and negative half cycle. The filter unit 54 of the present embodiment includes 2 low-pass filter circuits so as to respectively filter the modulated wave with separated positive and negative half cycle.

The switching unit 56 is coupled to the output of the filter unit 54, for converting by switching the second DC pulse with separated positive and negative half cycle into the modulated AC voltage to the lamp for use. The switching unit 56 of the present embodiment provides different conduction paths for the second DC pulse to travel to the lamp via a plurality of switches. The switching unit 56 shown in FIG. 7 includes switch SW5 and switch SW6, and the lamp is coupled at the output conduction path of the switching unit 56. The first conduction path is formed when the switch SW5 is in conduction, thereby the second DC pulse with the positive half cycle flows in the order and direction of the switch SW5 and the lamp; and the second conduction path is formed when the switch SW6 is in conduction, thereby the second DC pulse with the negative half cycle flows in the order and direction of the lamp and the switch SW6. Thereby the directions of the aforementioned first and second conduction path are opposite to each other for the second DC pulse transmitted to the lamp; in other words, the switching unit 56 may convert the second DC pulse with separated positive and negative half cycle into a sine wave for use by the lamp.

The control unit 58 is coupled between the switching unit 56 and the modulator unit 52; the control unit 58 is primarily for controlling the operation of the switching unit 56 and the modulator unit 52. The control unit 58 outputs two control signals PWM2, PWM3 to the pulse width modulation driving circuit 521 according to an input voltage Vset, the input voltage Vset is used for adjusting the voltage of the sine wave that is provided to the lamp for use.

Furthermore, in order to ensure the voltage of the sine wave utilized by the lamp accurately adheres to the input voltage Vset, the control unit 58 adopts feedback control mechanism, the feedback control mechanism is the same as aforementioned FIG. 6, therefore will not be repeated. Additionally, the control unit 58 also provides control to the switching unit 56, so that when the AC voltage is at the positive half cycle then the control unit 58 control to conduct the switch SW5 and cut-off the switch SW6; on the other hand, when the AC voltage is at the negative half cycle then the control unit 58 controls to conduct the switch SW6 and cut-off the switch SW5.

The aforementioned power switch may be an insulated gate bipolar transistor (IGBT) or a metal-oxide-semiconductor field-effect transistor (MOSFET). The plurality of switches may be a silicon controlled rectifier (SCR). The control unit may be a micro-processor, a micro controller unit (MCU) or a system on chip (SOC), however the examples of the power switch, the plurality of switches, and the control unit given here are not meant to be limiting, any other electronic components that may accomplish equivalent functions are deem to be within the scope of the present invention.

As aforementioned, the sine wave light modulation control method of the present invention provides a sine wave directly for use by the lamp after being processed via the steps in FIG. 3. Thereby, through the modulator unit the voltage of the sine wave may be controlled and adjusted. Therefore, the inrush current to the lamp may be completely cancelled by the present invention, and the high frequency noise of the prior art may be eliminated. Thus, the light modulation method of the present invention may keep the power factor at above 98%, so as to achieve a high energy efficiency.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A sine wave light modulation control method for controlling the light output of a lamp, the method comprising:
providing an AC voltage;
rectifying the AC voltage into a first DC pulse;
modulating the first DC pulse into a modulated wave via pulse width modulation;
filtering the modulated wave into a second DC pulse; and
providing a switching unit for switching the second DC pulse into a modulated AC voltage for output to the lamp;
wherein switching of the switching unit is achieved by alternatingly switching the second DC pulse to a first conduction path and a second conduction path so as to output the modulated AC voltage, and the directions of the first conduction path and the second conduction path for the second DC pulse transmitted to the lamp are opposite to each other.

2. The sine wave light modulation control method according to claim 1, characterized in that the AC voltage is rectified by a full wave rectifier circuit.

3. The sine wave light modulation control method according to claim 1, characterized in that the AC voltage is rectified by a positive half-wave rectifier circuit and a negative half-wave rectifier circuit.

4. The sine wave light modulation control method according to claim 1, characterized in that the first DC pulse is modulated by a pulse width modulation circuit so as to control at least the conduction of a power switch, and the first DC pulse passes through the power switch in order to be modulated into the modulated wave.

5. The sine wave light modulation control method according to claim 4, characterized in that a duty cycle used by the pulse width modulation circuit is adjusted according to a control unit.

6. The sine wave light modulation control method according to claim 5, characterized in that the control unit adjusts the duty cycle according to an input voltage and a feedback voltage of the lamp.

7. The sine wave light modulation control method according to claim 6, characterized in that when the feedback voltage is greater than the input voltage, the control unit lowers the duty cycle.

8. The sine wave light modulation control method according to claim 6, characterized in that the control unit increases the duty cycle when the feedback voltage is less than the input voltage.

9. The sine wave light modulation control method according to claim 6, characterized in that the conduction to the first conduction path and the second conduction path is controlled by the control unit.

10. The sine wave light modulation control method according to claim 1, characterized in that the modulated wave is filtered by a lower pass filter.

11. A sine wave light modulation control device for controlling the light output of a lamp, comprising:
a rectifier unit, for rectifying an AC voltage into a first DC pulse;
a modulator unit, coupled to the rectifier unit, for modulating the first DC pulse into a modulated wave via pulse width modulation;
a filter unit, coupled to the modulator unit, for filtering the modulated wave into a second DC pulse;
a switching unit, coupled to the filter unit, the switching unit providing a first conduction path and a second conduction path for alternatingly switching between the two paths so as to output a modulated AC voltage for use by the lamp; and
a control unit, coupled to the switching unit, the control unit being used for controlling the switching unit to alternatingly provide the second DC pulse to the first conduction path and to the second conduction path so as to output the modulated AC voltage, whereby the directions of the first conduction path and the second conduction path for the second DC pulse transmitted to the lamp are opposite to each other.

12. The sine wave light modulation control device according to claim 11, characterized in that the rectifier unit is a full wave rectifier circuit.

13. The sine wave light modulation control device according to claim 11, characterized in that the rectifier unit comprises a positive half-wave rectifier circuit and a negative half-wave rectifier circuit.

14. The sine wave light modulation control device according to claim 11, characterized in that the modulator unit comprises:
a pulse width modulation circuit and at least a power switch, wherein the pulse width modulation circuit controls the conduction of the power switch, so as to modulate the first DC pulse that passes through the power switch into a modulated wave;
wherein the control unit is coupled to the modulator unit, and the control unit controls the adjustment of the duty cycle of a PWM control signal used by the pulse width modulation circuit of the modulator unit.

15. The sine wave light modulation control device according to claim 14, characterized in that the power switch is an insulated gate bipolar transistor (IGBT) or a metal-oxide-semiconductor field-effect transistor (MOSFET).

16. The sine wave light modulation control device according to claim 14, characterized in that the control unit adjusts the duty cycle according to an input voltage and a feedback voltage of the lamp, wherein the control unit lowers the duty cycle of the PWM control signal when the feedback voltage is greater than the input voltage, and the control unit increases the duty cycle of the PWM control signal when the feedback voltage is less than the input voltage.

17. The sine wave light modulation control device according to claim 11, characterized in that the control unit causes the first conduction path to conduct during the positive half cycle of the AC voltage and causes the second conduction path to conduct during the negative half cycle of the AC voltage.

18. The sine wave light modulation control device according to claim 11, characterized in that the switching unit comprising a plurality of switches, the control unit forms the first conduction path and the second conduction path by controlling the conduction of the plurality of switches.

19. The sine wave light modulation control device according to claim 18, characterized in that each of the plurality of switches is a silicon controlled rectifier (SCR).

20. The sine wave light modulation control device according to claim 11, characterized in that the filter unit is a low pass filter.
